(19) United States
(12) Patent Application Publication
(10) Pub. No.: US 2024/0239942 A1
(43) Pub. Date: Jul. 18, 2024

(54) POLYPROPYLENE RESIN COMPOSITION, METHOD FOR PRODUCING SAME, SHEET MOLDED BODY AND CONTAINER

(71) Applicant: Basell Poliolefine Italia S.r.l., Milano (IT)

(72) Inventors: Minoru Kuriyama, Kawasaki (JP); Takeshi Nakajima, Kawasaki (JP)

(73) Assignee: Basell Poliolefine Italia S.r.l., Milano (IT)

(21) Appl. No.: 18/572,158

(22) PCT Filed: Jun. 24, 2022
(86) PCT No.: PCT/JP2022/025365

§ 371 Date: Mar. 1, 2024

(30) Foreign Application Priority Data
Jun. 25, 2021 (JP) 2021-105707

(51) Int. Cl. C08F 295/00; C08J 5/18; C08K 3/34

(52) U.S. Cl. CPC C08F 295/00; C08J 5/18; C08K 3/34; C08J 2353/00; C08K 2003/343

(57) ABSTRACT

A polypropylene-based resin composition made from or containing (A) a polypropylene-based resin including (a1) a continuous phase consisting of a propylene polymer and (a2) a rubber phase consisting of a copolymer of ethylene and an α-olefin having 3-10 carbon atoms.

### FIELD OF THE INVENTION

In general, the present disclosure relates to the field of chemistry. More specifically, the present disclosure relates to polymer chemistry. In particular, the present disclosure relates to a polypropylene-based resin composition, a method for producing the same, a sheet molding made therefrom, and a container made therefrom.

### BACKGROUND OF THE INVENTION

Polypropylene is used for various purposes, relying on polypropylene's physical properties such as impact resistance, rigidity, transparency, chemical resistance, and heat resistance. In some instances, a polypropylene-based resin composition is used to make an injection molded article.

### SUMMARY OF THE INVENTION

In a general embodiment, the present disclosure provides a polypropylene-based resin composition made from or containing:
(A) a polypropylene-based resin made from or containing
   (a1) a continuous phase consisting of a propylene polymer, having a content of ethylene-derived units of 0.5% by weight or less, based upon the total weight of the propylene polymer, and a ratio (M_{w}/Mₙ) between the weight average molecular weight M_{w} and the number average molecular weight Mₙ of less than 7, and
   (a2) from 27 to 45% by weight of a rubber phase consisting of a copolymer of ethylene and an α-olefin having 3 to 10 carbon atoms, based upon the total weight of the polypropylene-based resin (A), wherein the copolymer has a content of ethylene-derived units of 25 to 85% by weight, based upon the total weight of the copolymer, and
(C) an inorganic filler, as an optional component,
wherein
   (i) when weight m1 represented as the difference of [total weight of the polypropylene-based resin composition−the weight of the inorganic filler (C)] is 100% by weight, the weight m2 of the polypropylene-based resin (A) is from 90% by weight or more to below 100% by weight, and the content of the inorganic filler (C) is 0 to 60 parts by weight with respect to 100 parts by weight of the (A),
wherein
   (ii) when the inorganic filler (C) is not included, the MFR of the polypropylene-based resin composition at a temperature of 230° C. and a load of 2.16 kg is 0.1 to 3.0 g/10 min,
wherein the xylene-soluble portion of the polypropylene-based resin (A) has an intrinsic viscosity in tetrahydronaphthalene at 135° C. of 2.5 to 5.5 dl/g, and
the MFR of the polypropylene-based resin (A) at a temperature of 230° C. and a load of 2.16 kg is 0.1 to 3.0 g/10 minutes.

In some embodiments, the polypropylene-based resin (A) has a crystallization peak observed between 85 and 105° C. with a calorific value of 0.5 to 10 J/g in DSC measurement.

In some embodiments, the propylene polymer (a1) and the copolymer (a2) are mixed by polymerization, and the polypropylene-based resin (A) is a polymerization mixture prepared by using a catalyst containing:
(a) a solid catalyst containing magnesium, titanium, halogen, and a phthalate-based compound as an electron donor compound,
(b) an organoaluminum compound, and
(c) an organosilicon compound as an external electron donor compound.

In some embodiments, the present disclosure provides a method for producing the polypropylene-based resin composition including the step of: polymerizing ethylene monomer and an α-olefin monomer having 3 to 10 carbon atoms, in the presence of the propylene polymer (a1), thereby yielding polypropylene-based resin (A), using a catalyst containing:
(a) a solid catalyst containing magnesium, titanium, halogen, and a phthalate-based compound as an electron donor compound,
(b) an organoaluminum compound, and
(c) an organosilicon compound as an external electron donor compound.

In some embodiments, the present disclosure provides a sheet molding made from or containing the polypropylene-based resin composition.

In some embodiments, the present disclosure provides a container made from or containing the sheet molding.

In some embodiments, the sheet molding is used in applications selected from the group consisting of miscellaneous goods, daily necessities, home appliance parts, electrical and electronic parts, automobile parts, housing parts, toy parts, furniture parts, building material parts, packaging parts, industrial materials, logistics materials, agricultural materials, and plastic cardboard.

### BRIEF DESCRIPTION OF THE DRAWINGS

FIG. 1 provides a perspective view of a sheet molding.

FIG. 2 provides a perspective view of a container.

FIG. 3 provides a DSC chart from polypropylene-based resin pellets.

### DETAILED DESCRIPTION OF THE INVENTION

### <Polypropylene-Based Resin Composition>

In some embodiments, the polypropylene-based resin composition is made from or containing
(A) a polypropylene-based resin (hereinafter also referred to as component (A)) including
   (a1) a continuous phase consisting of a propylene polymer (hereinafter also referred to as component (a1)) and
   (a2) a rubber phase consisting of a copolymer of ethylene and α-olefin having 3 to 10 carbon atoms (hereinafter also referred to as component (a2)).

In some embodiments, the polypropylene-based resin composition is further made from or containing (C) an inorganic filler (hereinafter also referred to as component (C)).

In some embodiments, when weight m1 represented as the difference between [total weight of the polypropylene-based resin composition−the weight of the inorganic filler (C)] is 100% by weight, the weight m2 represented as the weight of the component (A) is 90% by weight or more to below 100% by weight. In some embodiments, the lower limit is 90% by weight or more, alternatively 95% by weight or more, alternatively 99% by weight or more.

In some embodiments, weight m2 is less than the upper limit of the above range, and the polypropylene-based resin composition is further made from or containing other components such as antioxidant or neutralizing agents.

In some embodiments, the content of the inorganic filler (C) is 0 to 60 parts by weight with respect to the total 100 parts by weight of component (A). In some embodiments, the upper limit is 40 parts by weight or less, alternatively 20 parts by weight or less.

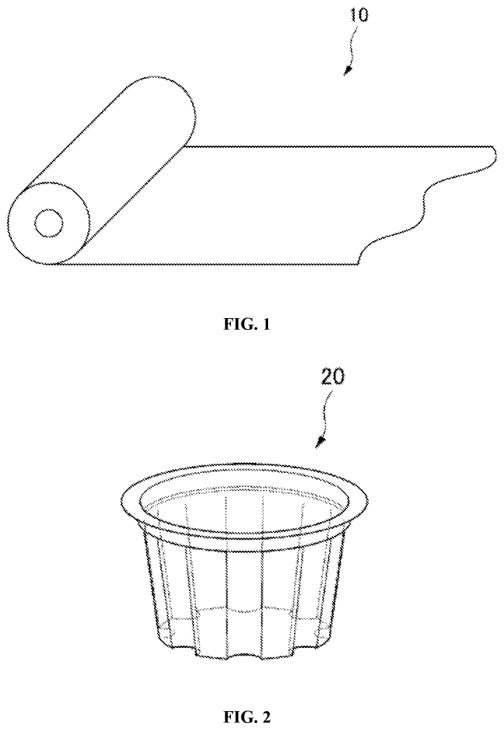

In some embodiments, when the content of component (C) is at or less than the upper limit of the above range, molding a sheet molding from the polypropylene-based resin composition and molding a container from the sheet molding are improved. FIGS. 1 and 2 show a sheet molding 10 and a cup-shaped container 20 formed from a sheet molding.

In some embodiments, component (C) increases the rigidity (stiffness) of the sheet molding.

In some embodiments and when the component (C) is not included, the MFR of the polypropylene-based resin composition at a temperature of 230° C. and a load of 2.16 kg is 0.1 to 3.0 g/10 minutes. In some embodiments, the lower limit is 0.2 g/10 minutes or more, alternatively 0.3 g/10 minutes or more. In some embodiments, the upper limit is 2.5 g/10 minutes or less, alternatively 1.8 g/10 minutes or less, alternatively 1.0 g/10 minutes or less. In some embodiments, the range is selected from the group consisting of 0.1 to 2.5 g/10 minutes, 0.1 to 1.8 g/10 minutes, 0.1 to 1.0 g/10 minutes, 0.2 to 3.0 g/10 minutes, 0.2 to 2.5 g/10 minutes, 0.2 to 1.8 g/10 minutes, 0.2 to 1.0 g/10 minutes, 0.3 to 3.0 g/10 minutes, 0.3 to 2.5 g/10 minutes, 0.3 to 1.8 g/10 minutes, and 0.3 to 1.0 g/10 minutes.

In some embodiments, when the MFR is at or more than the lower limit of the above range, sheet moldability is improved. In some instances, manufacturing is difficult when MFR is less than 0.1 g/10 minutes.

In some embodiments, when the MFR is at or less than the upper limit of the above range, sheet moldability (drawdown resistance) and sheet productivity are improved, and the impact resistance of the sheet molding at temperatures of about −40° ° C. increases.

### [Polypropylene-Based Resin (A)]

In some embodiments, polypropylene-based resin (A) is an impact-resistant polypropylene polymer specified by JIS K6921-1, and made from or containing two or more phases, including (a1) a continuous phase of propylene polymer (component (a1)) and (a2) a rubber phase of ethylene/α-olefin copolymer (component (a2)) present in the continuous phase as a dispersed phase.

In some embodiments, polypropylene-based resin (A) is a mixed resin, wherein component (a1) and component (a2) are mixed during polymerization. In some embodiments, polypropylene-based resin (A) is a mixed resin, wherein component (a1) and component (a2), obtained separately, are mixed by melt kneading. In some embodiments, component (a1) and component (a2) are mixed during polymerization (polymerization mixture). It is believed that a polymerization mixture provides improved rigidity, low-temperature impact resistance and tensile properties (hereinafter also referred to as “mechanical physical property balance”).

In some embodiments and in the polymerization mixture, component (a1) and component (a2) are mixed on the submicron order.

In some embodiments, the intrinsic viscosity of the xylene-soluble portion of the polypropylene-based resin (A) (hereinafter also referred to as “XSIV”) is 2.5 to 5.5 dl/g. In some embodiments, the lower limit is 2.7 dl/g or more. In some embodiments, the upper limit is 4.5 dl/g or less, alternatively 4.0 dl/g or less, alternatively 3.5 dl/g or less. In some embodiments, the range is selected from the group consisting of 2.5 to 4.5 dl/g, 2.5 to 4.0 dl/g, 2.5 to 3.5 dl/g, 2.7 to 5.5 dl/g, 2.7 to 4.5 dl/g, 2.7 to 4.0 dl/g, and 2.7 to 3.5 dl/g.

In some embodiments, when the intrinsic viscosity is at or more than the lower limit of the above range, the impact resistance of the sheet molding at temperatures of about −40° C. increases. In some embodiments, when the intrinsic viscosity is at or less than the upper limit of the above range, the productivity of the polypropylene-based resin (A) increases. In some embodiments, the sheet moldability is improved, and the impact resistance of the sheet molding at temperatures of about −40° C. increases.

In some embodiments, the ratio of the weight average molecular weight M_{w} to the number average molecular weight Mₙ (M_{w}/Mₙ), which is an index of the molecular weight distribution of the propylene polymer (component (a1)), is less than 7. In some embodiments, the ratio is less than 7, and the impact resistance of the sheet molding at temperatures of about −40° C. increases. In some embodiments, the lower limit of the ratio is 3 or more.

In some embodiments, the ethylene-derived unit content (hereinafter also referred to as “C2”) in the propylene polymer (component (a1)) is 0.5% by weight or less, alternatively 0.3% by weight or less, with respect to the total weight of the propylene polymer.

In some embodiments, when C2 is at or less than the upper limit value, the rigidity of the sheet molding increases.

In some embodiments, the lower limit of C2 is 0% by weight.

In some embodiments, the propylene polymer is a polypropylene homopolymer, consisting of propylene-derived units. In some embodiments, the propylene polymer is a copolymer, consisting of (i) between 99.5% by weight or more and less than 100% by weight of propylene-derived units and (ii) between more than 0% by weight and 0.5% by weight or less of ethylene-derived units.

In some embodiments, the ethylene/α-olefin copolymer (component (a2)) is a copolymer, having an ethylene-derived unit and α-olefin-derived unit having 3 to 10 carbon atoms.

In some embodiments, the content of ethylene-derived units in component (a2) is 25 to 85% by weight with respect to the total weight of component (a2). In some embodiments, the lower limit is 28% by weight or more, alternatively 33% by weight or more, alternatively 40% by weight or more, alternatively 45% by weight or more. In some embodiments, the upper limit is 70% by weight or less, alternatively 60% by weight or less, alternatively 55% by weight or less. In some embodiments, the content of ethylene-derived units in component (a2) is in a range selected from the group consisting of 25 to 70% by weight, 25 to 60% by weight, 25 to 55% by weight, 28 to 85% by weight, 28 to 70% by weight, 28 to 60% by weight, 28 to 55% by weight, 33 to 85% by weight, 33 to 70% by weight, 33 to 60% by weight, 33 to 55% by weight, 40 to 85% by weight, 40 to 70% by weight, 40 to 60% by weight, 40 to 55% by weight, 45 to 85% by weight, 45 to 70% by weight, 45 to 60% by weight, and 45 to 55% by weight.

In some embodiments, when the content of ethylene-derived units is at or more than the lower limit of the above range, the impact resistance of the sheet molding at temperatures of about −40° C. increases.

In some embodiments, when the content of ethylene-derived units is at or less than the upper limit of the above range, the risk of clogging the flow path on the production equipment due to the deterioration of powder fluidity during the production of the polypropylene-based resin (A) is reduced, thereby permitting continuous production of the polypropylene-based resin (A).

In some embodiments, the content of the ethylene/α-olefin copolymer (component (a2)) with respect to the total weight of the polypropylene-based resin (A) is 27 to 45% by weight. In some embodiments, the lower limit is 29% by weight or more, alternatively 32% by weight or more. In some embodiments, the upper limit is 42% by weight or less, alternatively 38% by weight or less. In some embodiments, the content of the ethylene/α-olefin copolymer (component (a2)) is in a range selected from the group consisting of 27 to 42% by weight, 27 to 38% by weight, 29 to 45% by weight, 29 to 42% by weight, 29 to 38% by weight, 32 to 45% by weight, 32 to 42% by weight, and 32 to 38% by weight.

In some embodiments, the content of the ethylene/α-olefin copolymer (component (a2)) is at or more than the lower limit of the above range, and the impact resistance of the sheet molding at temperatures of about −40° C. increases.

In some embodiments, the content of the ethylene/α-olefin copolymer (component (a2)) is at or less than the upper limit of the above range, and the risk of clogging the flow path on the production equipment due to the deterioration of powder fluidity during the production of the polypropylene-based resin (A) is reduced, thereby permitting continuous production of the polypropylene-based resin (A).

In some embodiments and depending on the content of component (a2), the content of component (a1) is 55 to 73% by weight with respect to the total weight of the polypropylene-based resin (A). In some embodiments, the lower limit is 58% by weight or more, alternatively 62% by weight or more. In some embodiments, the upper limit is 71% by weight or less, alternatively 68% by weight or less. In some embodiments, the content of component (a1) is a range selected from the group consisting of 55 to 71% by weight, 55 to 68% by weight, 58 to 73% by weight, 58 to 71% by weight, 58 to 68% by weight, 62 to 73% by weight, 62 to 71% by weight, and 62 to 68% by weight.

In some embodiments, the ethylene/α-olefin copolymer (component (a2)) is made from or containing an α-olefin selected from the group consisting of propylene (1-propene), 1-butene, 1-pentene, 1-hexene, and 1-octene.

In some embodiments, component (a2) is selected from the group consisting of ethylene/propylene copolymer, ethylene/butene copolymer, ethylene/pentene copolymer, ethylene/hexene copolymer, and ethylene/octene copolymer.

In some embodiments, component (a2) is an ethylene/propylene copolymers.

In some embodiments, the MFR of the polypropylene-based resin (A) at a temperature of 230° C. and a load of 2.16 kg is 0.1 to 3.0 g/10 minutes. In some embodiments, the lower limit is 0.2 g/10 minutes or more, alternatively 0.3 g/10 minutes or more. In some embodiments, the upper limit is 2.5 g/10 minutes or less, alternatively 1.8 g/10 minutes or less, alternatively 1.0 g/10 minutes or less. In some embodiments, the range of the MFR is selected from the group consisting of 0.1 to 2.5 g/10 minutes, 0.1 to 1.8 g/10 minutes, 0.1 to 1.0 g/10 minutes, 0.2 to 3.0 g/10 minutes, 2.0 to 2.5 g/10 minutes, 0.2 to 1.8 g/10 minutes, 0.2 to 1.0 g/10 minutes, 0.3 to 3.0 g/10 minutes, 0.3 to 2.5 g/10 minutes, 0.3 to 1.8 g/10 minutes, and 0.3 to 1.0 g/10 minutes.

In some embodiments, the MFR is at or more than the lower limit of the above range, and sheet moldability is improved. In some instances, manufacturing is difficult when the MFR is less than 0.1 g/10 minutes.

In some embodiments, when the MFR is at or less than the upper limit of the above range, sheet moldability (drawdown resistance) and sheet productivity are improved, and the impact resistance of the sheet molding at temperatures of about −40° C. increases.

In some embodiments and in DSC (differential scanning calorimetry) of the polypropylene-based resin (A), a crystallization peak is observed between 85 and 105° C. It is believed that this crystallization peak originates from the crystallization of the polyethylene component of the ethylene/α-olefin copolymer (component (a2)).

It is believed that the calorific value (ΔHc) of the crystallization peak observed between 85 and 105° ° C. in DSC is an index of the amount of polyethylene component contained in the polypropylene-based resin (A) and depends on the content of component (a2) in the polypropylene-based resin (A). It is believed that in addition to the ethylene-derived unit content of component (a2), the calorific value depends on the catalyst and polymerization conditions during production of the polypropylene-based resin (A).

In some embodiments and from the viewpoint of increasing the impact resistance at temperatures of about −40° C., the lower limit of ΔHc observed between 85 and 105° C. is 0.5 J/g or more, alternatively 1.0 J/g or more. In some embodiments, when ΔHc is 10 J/g or less, the rigidity is maintained, and the affinity between component (a1) and component (a2) is maintained, thereby the balance between the rigidity and impact resistance is improved. In some embodiments, the upper limit of ΔHc is 8.0 J/g or less. In some embodiments, the range of ΔHc is selected from the group consisting of 0.5 to 10 J/g, 0.5 to 8.0 J/g, 1.0 to 10 J/g, and 1.0 to 8.0 J/g.

### [Inorganic Filler (C)]

In some embodiments, the inorganic filler (C) is selected from the group consisting of natural silicic acid or silicate; synthetic silicic acid or silicate; carbonates; hydroxides; oxides. In some embodiments, the natural silicic acid or silicate is selected from the group consisting of talc, kaolinite, clay, virophyllite, selenite, wollastonite, and mica. In some embodiments, the synthetic silicic acid or silicate is selected from the group consisting of hydrated calcium silicate, hydrated aluminum silicate, hydrated silicic acid, and anhydrous silicic acid. In some embodiments, the carbonate is selected from the group consisting of precipitated calcium carbonate, ground calcium carbonate, and magnesium carbonate. In some embodiments, the hydroxide is selected from the group consisting of aluminum hydroxide and magnesium hydroxide. In some embodiments, the oxide is selected from the group consisting of zinc oxide and magnesium oxide.

In some embodiments and from the viewpoint of shape, the inorganic filler is selected from the group consisting of powdered fillers; plate-shaped fillers; whisker-like fillers; balloon-like fillers; and fibrous fillers. In some embodiments, the powdered fillers are synthetic silicic acid or silicate. In some embodiments, the synthetic silicic acid or silicate is selected from the group consisting of hydrated calcium silicate, hydrated aluminum silicate, hydrated silicic acid, and anhydrous silicic acid; In some embodiments, the plate-shaped fillers are selected from the group consisting of talc, kaolinite, clay, and mica. In some embodiments, the whisker-like fillers are selected from the group consisting of basic magnesium sulfate whiskers, calcium titanate whiskers, aluminum borate whiskers, sepiolite, PMF (Processed Mineral Filler), xonotlite, potassium titanate, and elastadite. In some embodiments, the balloon-like fillers are selected from the group consisting of glass balloons and fly ash balloons.

In some embodiments, fibrous fillers are glass fibers.

In some embodiments, a single type of inorganic filler is used. In some embodiments, two or more types are used in combination. In some embodiments, the inorganic fillers are subjected to surface treatment, thereby improving the dispersibility of these fillers. In some embodiments and from the viewpoint of improving the balance of mechanical properties by promoting the orientation of polypropylene crystals in the sheet molding, the inorganic filler is a plate-shaped inorganic filler. In some embodiments, the plate-shaped inorganic filler is selected from the group consisting of talc and mica. In some embodiments, the plate-shaped inorganic filler is talc.

In some embodiments, the volume average particle diameter of the inorganic filler (C) is 1 to 10 μm, alternatively 2 to 7 μm. In some embodiments, when the volume average particle diameter is within the above range, the mechanical property balance of the injection molding is high. In some embodiments, the volume average particle diameter is measured as a 50% diameter in a volume-based integrated fraction by a laser diffraction method (based on JIS R1629).

### Other Components

In some embodiments, the polypropylene-based resin composition is made from or containing synthetic resins or synthetic rubbers other than the polypropylene-based resin (A), and additives, as optional components, within a range that does not impair the properties of the polypropylene-based resin composition.

In some embodiments, the additives are selected from the group consisting of antioxidants, neutralizing agents, nucleating agents, weathering agents, pigments (organic or inorganic), internal and external lubricants, anti-blocking agents, antistatic agents, chlorine absorbers, heat stabilizers, light stabilizers, ultraviolet absorbers, slip agents, antifogging agents, flame retardants, dispersants, copper damage inhibitors, plasticizers, foaming agents, antifoaming agents, crosslinking agents, peroxides, and oil extenders. In some embodiments, the additives are used alone or in combination with one or more other additives.

### <Method for Producing Polypropylene-Based Resin Composition>

In some embodiments, the present disclosure provides a method for producing the polypropylene-based resin composition, wherein a polypropylene-based resin (A) and an optional component of inorganic filler (C) are mixed and then melt-kneaded.

In some embodiments, the mixing method is dry blending using a mixer such as a Henschel mixer, a tumbler, or a ribbon mixer.

In some embodiments, the melt-kneading method includes mixing while melting. In some embodiments, the mixer is selected from the group consisting of a single-screw extruder, a twin-screw extruder, a Banbury mixer, a kneader, and a roll mill. In some embodiments, the melting temperature, during melt-kneading, is 160 to 350° C., alternatively 170 to 260° C. In some embodiments, pelletizing is conducted after melt-kneading.

In some embodiments, component (C) is dry blended to the pellets made from or containing component (A). In some embodiments, the dry blended component (C) is uniformly mixed with component (A), which is melted upon molding the polypropylene-based resin composition. In some embodiments, a masterbatch, in which a high concentration of component (C) has been melt-kneaded with the resin component, is added to component (A) and melt-kneaded. In some embodiments, a masterbatch is dry blended with the pellets containing component (A). In some embodiments, the ratio of the resin component contained in the masterbatch and the amount of the masterbatch added are adjusted such that the resin component contained in the masterbatch does not affect the physical properties of the polypropylene-based resin composition.

### [Production Method of Polypropylene-Based Resin (A)]

In some embodiments, polypropylene-based resin (A) is obtained by mixing a propylene polymer (component (a1)) and an ethylene/α-olefin copolymer (component (a2)) during polymerization. In some embodiments, component (a1) and component (a2), produced separately, are mixed by melt-kneading.

In some embodiments, the polypropylene-based resin (A) is a polymerization mixture, wherein component (a1) and component (a2) are mixed during polymerization.

Such a polymerization mixture is obtained by polymerizing ethylene monomer and α-olefin monomer in the presence of component (a1). According to this method, productivity is increased, and the dispersibility of component (a2) in component (a1) is increased, such that the balance of mechanical physical properties of the sheet molding obtained using this method is improved.

In some embodiments, a propylene monomer is used as the α-olefin monomer.

In some embodiments, a multistage polymerization method is used. In some embodiments, the polymerization mixture is obtained as follows: propylene monomer is polymerized to obtain a propylene polymer in the first stage polymerization reactor of a polymerization apparatus equipped with two stages of polymerization reactors, and the resulting polypropylene polymer is supplied to the second stage polymerization reactor and the ethylene monomer and propylene monomer are polymerized therein. In some embodiments, propylene monomer and ethylene monomer are polymerized to obtain a propylene polymer in the first stage polymerization reactor.

In some embodiments, the first stage polymerization conditions include a slurry polymerization method, wherein propylene is in the liquid phase and the monomer density and productivity are high. In some embodiments and as the second-stage polymerization conditions, a gas phase polymerization method produces a copolymer with high solubility in propylene.

In some embodiments, the polymerization temperature is 50 to 90° C., alternatively 60 to 90° C., alternatively 70 to 90° C. In some embodiments, the polymerization temperature is at or more than the lower limit of the above range, and the productivity and the stereoregularity of the resulting polypropylene are improved.

In some embodiments, the polymerization pressure is 25 to 60 bar (2.5 to 6.0 MPa), alternatively 33 to 45 bar (3.3 to 4.5 MPa), when carried out in a liquid phase. In some embodiments, the polymerization is carried out in a gas phase, and the pressure is 5 to 30 bar (0.5 to 3.0 MPa), alternatively 8 to 30 bar (0.8 to 3.0 MPa).

In some embodiments, polymerization (polymerization of propylene monomer or polymerization of ethylene monomer and propylene monomer) is carried out using a catalyst. In some embodiments, hydrogen is added to adjust the molecular weight. In some embodiments, by adjusting the molecular weight of the propylene polymer or ethylene/propylene copolymer, the MFR of the polypropylene-based resin (A) and the MFR of the resulting polypropylene-based resin composition are adjusted. In some embodiments, before the polymerization in the first stage polymerization reactor, propylene is prepolymerized, thereby forming polymer chains in the solid catalyst component. It is believed that polymer chains serve as a foothold for the subsequent main polymerization. In some embodiments, prepolymerization is carried out at a temperature of 40° C. or below, alternatively 30° C. or below, alternatively 20° C. or below.

In some embodiments, the catalyst for polymerizing ethylene monomer and propylene monomer in the presence of the propylene polymer is a stereospecific Ziegler-Natta catalyst. In some embodiments, the catalyst is made from or containing the following component (a), component (b), and component (c) (hereinafter also referred to as “catalyst (X)”):
(a) a solid catalyst containing magnesium, titanium, halogen, and a phthalate-based compound as an electron donor compound;
(b) an organoaluminum compound; and
(c) an organosilicon compound as an external electron donor compound.

In some embodiments, the present disclosure provides a method for producing the polypropylene-based resin (A) including the step of: polymerizing ethylene monomer and α-olefin monomer, using a catalyst (X) in the presence of the propylene polymer. In some embodiments, the α-olefin monomer is a propylene monomer.

In some embodiments, the molecular weight and stereoregularity distribution of the resulting propylene polymer differ depending on the catalyst used, alternatively on the electron donor compound of (a). In some embodiments, these differences affect crystallization behavior. In some embodiments, the molecular weight distribution and stereoregularity distribution change by thermal deterioration, during melting and kneading, and peroxide treatment.

In some embodiments, component (a) is prepared using a titanium compound, a magnesium compound, and an electron donor compound.

In some embodiments, the titanium compound used in component (a) is a tetravalent titanium compound represented by the formula: Ti(OR)gX4-g, wherein R is a hydrocarbon group, X is a halogen, and 0<g<4.

In some embodiments, the hydrocarbon group is selected from the group consisting of methyl, ethyl, propyl, and butyl. In some embodiments, the halogen is Cl or Br.

In some embodiments, the titanium compounds are selected from the group consisting of titanium tetrahalides; trihalogenated alkoxytitanium; dihalogenated alkoxytitanium; monohalogenated trialkoxytitanium; tetraalkoxytitanium. In some embodiments, the titanium tetrahalides are selected from the group consisting of TiCl4, TiBr4, and Til4. In some embodiments, the trihalogenated alkoxytitanium is selected from the group consisting of Ti(OCH3)Cl3, Ti(OC2H5)Cl3, Ti(On-C4H9)Cl3, Ti(OC2H5)Br3, and Ti(O-isoC4H9)Br3. In some embodiments, the dihalogenated alkoxytitanium is selected from the group consisting of Ti(OCH3)₂C12, Ti(OC2H5)2C12, Ti(On-C4H9)₂C12, and Ti(OC2H5)2Br2. In some embodiments, the monohalogenated trialkoxytitanium is selected from the group consisting of Ti(OCH₃)₃Cl, Ti(OC₂H₅)3Cl, Ti(Oₙ—C₄H₉)₃Cl, and Ti(OC₂H₅)₃Br. In some embodiments, the tetraalkoxytitanium is selected from the group consisting of Ti(OCH3)₄, Ti(OC2H5)4, Ti(On-C4H9)4. In some embodiments, the titanium compounds are used alone or in combination of two or more types.

In some embodiments, the titanium compounds are halogen-containing titanium compounds, alternatively titanium tetrahalides, alternatively titanium tetrachloride (TiCl4).

In some embodiments, the magnesium compounds used in component (a) have a magnesium-carbon bond or a magnesium-hydrogen bond. In some embodiments, the magnesium compounds are selected from the group consisting of dimethylmagnesium, diethylmagnesium, dipropylmagnesium, dibutylmagnesium, diamylmagnesium, dihexylmagnesium, didecylmagnesium, ethylmagnesium chloride, propylmagnesium chloride, butylmagnesium chloride, hexylmagnesium chloride, amylmagnesium chloride, butyl ethoxymagnesium, ethylbutylmagnesium, and butylmagnesium hydride. In some embodiments, the magnesium compounds are used in the form of a complex compound. In some embodiments, the complex compound is with an organoaluminium. In some embodiments, the magnesium compounds are used in a liquid or solid state. In some embodiments, the magnesium compounds are selected from the group consisting of magnesium halides; alkoxymagnesium halides; allyloxymagnesium halide alkoxymagnesium; dialkoxymagnesium and allyloxymagnesium. In some embodiments, the magnesium halides are selected from the group consisting of magnesium chloride, magnesium bromide, magnesium iodide, and magnesium fluoride. In some embodiments, the alkoxymagnesium halides is selected from the group consisting of magnesium methoxychloride, ethoxymagnesium chloride, isopropoxymagnesium chloride, butoxymagnesium chloride, and octoxymagnesium chloride. In some embodiments, the allyloxymagnesium halide is selected from the groujp consisting of phenoxymagnesium chloride and methylphenoxymagnesium chloride. In some embodiments, the alkoxymagnesium is selected from the group consisting of ethoxymagnesium, isopropoxymagnesium, butoxymagnesium, n-octoxymagnesium, and 2-ethylhexoxymagnesium. In some embodiments, the dialkoxymagnesium is selected from the group consisting of dimethoxymagnesium, diethoxymagnesium, dipropoxymagnesium, dibutoxymagnesium, and ethoxymethoxymagnesium. In some embodiments, the allyloxymagnesium is selected from the group consisting of ethoxypropoxymagnesium, butoxyethoxymagnesium, phenoxymagnesium, and dimethylphenoxymagnesium. In some embodiments, the magnesium compounds are used alone or in combination of two or more types.

In some embodiments, the electron donor compound used for component (a) contains a phthalate-based compound.

In some embodiments, the phthalate-based compounds are selected from the group consisting of monoethyl phthalate, dimethyl phthalate, methyl ethyl phthalate, mono-isobutyl phthalate, mono-normal butyl phthalate, diethyl phthalate, ethyl isobutyl phthalate, ethyl normal butyl phthalate, di-n-propyl phthalate, diisopropyl phthalate, di-n-butyl phthalate, diisobutyl phthalate, di-n-heptyl phthalate, di-2-ethylhexyl phthalate, di-n-octyl phthalate, dineopentyl phthalate, didecyl phthalate, benzyl butyl phthalate, and diphenyl phthalate. In some embodiments, the phthalate-based compound is diisobutyl phthalate.

In some embodiments, electron donor compounds in the solid catalyst other than phthalate-based compounds are selected from the group consisting of succinate-based compounds and diether-based compounds.

In some embodiments, the succinate-based compound is an ester of succinic acid or an ester of substituted succinic acid, having a substituent such as an alkyl group at the 1st or 2nd position of the succinic acid.

In some embodiments, the succinate-based compound is selected from the group consisting of diethyl succinate, dibutyl succinate, diethyl methyl succinate, diethyl diisopropyl succinate, and diallylethyl succinate.

In some embodiments, the diether-based compound is a 1,3-diether. In some embodiments, the 1,3-diether is selected from the group consisting of 2-(2-ethylhexyl)-1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2-(1-naphthyl)-1,3-dimethoxypropane, 2-(p-fluorophenyl)-1,3-dimethoxypropane, 2-(1-decahydronaphthyl)-1,3-dimethoxypropane, 2-(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-propyl-2-pentyl-1,3-diethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane, 2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimethoxypropane, 2,2-di-sec-butyl-1,3-dimethoxypropane, 2,2-di-tert-butyl-1,3-dimethoxypropane, 2,2-dineopentyl-1,3-dimethoxypropane, 2-isopropyl-2-isopentyl-1,3-dimethoxypropane, 2-phenyl-2-benzyl-1,3-dimethoxypropane, and 2-cyclohexyl-2-cyclohexylmethyl-1,3-dimethoxypropane.

In some embodiments, the 1,3-diether is selected from the group consisting of 1,1-bis(methoxymethyl)-cyclopentadiene; 1,1-bis(methoxymethyl)-2,3,4,5-tetramethylcyclopentadiene; 1,1-bis(methoxymethyl)-2,3,4,5-tetraphenylcyclopentadiene; 1,1-bis(methoxymethyl)-2,3,4,5-tetrafluorocyclopentadiene; 1,1-bis(methoxymethyl)-3,4-dicyclopentylcyclopentadiene; 1,1-bis(methoxymethyl)indene; 1,1-bis(methoxymethyl)-2,3-dimethylindene; 1,1-bis(methoxymethyl)-4,5,6,7-tetrahydroindene; 1,1-bis(methoxymethyl)-2,3,6,7-tetrafluoroindene; 1,1-bis(methoxymethyl)-4,7-dimethylindene; 1,1-bis(methoxymethyl)-3,6-dimethylindene; 1,1-bis(methoxymethyl)-4-phenylindene; 1,1-bis(methoxymethyl)-4-phenyl-2-methylindene; 1,1-bis(methoxymethyl)-4-cyclohexylindene; 1,1-bis(methoxymethyl)-7-(3,3,3-trifluoropropyl)indene; 1,1-bis(methoxymethyl)-7-trimethylsilylindene; 1,1-bis(methoxymethyl)-7-trifluoromethylindene; 1,1-bis(methoxymethyl)-4,7-dimethyl-4,5,6,7-tetrahydroindene; 1,1-bis(methoxymethyl)-7-methylindene; 1,1-bis(methoxymethyl)-7-cyclopentylindene; 1,1-bis(methoxymethyl)-7-isopropylindene; 1,1-bis(methoxymethyl)-7-cyclohexylindene; 1,1-bis(methoxymethyl)-7-tert-butylindene; 1,1-bis(methoxymethyl)-7-tert-butyl-2-methylindene; 1,1-bis(methoxymethyl)-7-phenylindene; 1,1-bis(methoxymethyl)-2-phenylindene; 1,1-bis(methoxymethyl)-1H-benzindene; 1,1-bis(methoxymethyl)-1H-2-methylbenzindene; 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; and 9,9-bis(methoxymethyl)-4-tert-butylfluorene.

In some embodiments, the halogen atom of component (a) is selected from the group consisting of fluorine, chlorine, bromine, iodine, and a mixture thereof. In some embodiment, the halogen atom of component (a) is chlorine.

In some embodiments, the organoaluminum compound of component (b) is selected from the group consisting of trialkylaluminum, trialkenylaluminum, dialkylaluminum alkoxide, alkylaluminum sesquialkoxide, partially alkoxylated alkyl aluminum having the average composition of R12.5Al(OR2)0.5, wherein R1 and R2 are hydrocarbon groups, dialkylaluminum halogenides, alkylaluminum sesquihalogenides, partially halogenated alkylaluminum, partially hydrogenated alkylaluminum, alkylaluminum dihydride, and partially alkoxylated and halogenated alkyl aluminums. In some embodiments, R¹ and R² are hydrocarbon groups different or the same. In some embodiments, the trialkylaluminum is selected from the group consisting of triethylaluminum and tributylaluminium. 1. In some embodiments, the trialkenylaluminum is triisoprenylaluminum. In some embodiments, the dialkylaluminum alkoxide is selected from the group consisting of diethylaluminum ethoxide and dibutylaluminum butoxide. In some embodiments, the alkylaluminum sesquialkoxide is selected from the group consisting of ethylaluminum sesquiethoxide and butylaluminum sesquibutoxide. In some embodiments, the dialkylaluminum halogenides are selected from the group consisting of diethylaluminum chloride, dibutylaluminum chloride, and diethylaluminum bromide. In some embodiments, the alkylaluminum sesquihalogenides are selected from the group consisting of ethyl aluminum sesquichloride, butyl aluminum sesquichloride, and ethyl aluminum sesquibromide. In some embodiments, the partially halogenated alkylaluminum is alkylaluminum dihalogenide. In some embodiments, the alkylaluminum dihalogenide is selected from the group consisting of ethylaluminum dichloride, propylaluminum dichloride, and butylaluminum dibromide. In some embodiments, the partially hydrogenated alkylaluminum is a dialkylaluminum hydride. In some embodiments, the dialkylaluminum hydride is selected from the group consisting of diethylaluminum hydride and dibutylaluminum hydride. In some embodiments, the alkylaluminum dihydride is selected from the group consisting of ethyl aluminum dihydride and propyl aluminum dihydride. In some embodiments, the partially alkoxylated and halogenated alkyl aluminums are selected from the groupconsisting of ethyl aluminum ethoxy chloride, butyl aluminum butoxy chloride, ethyl aluminum ethoxy bromide. In some embodiments, a component (b) compound is used alone or in combination of two or more component (b) compounds.

As an external electron donor compound of component (c), an organosilicon compound is used.

In some embodiments, the organosilicon compounds are selected from the group consisting of trimethylmethoxysilane, trimethylethoxysilane, dimethyldimethoxysilane, dimethyldiethoxysilane, diisopropyldimethoxysilane, t-butylmethyldimethoxysilane, t-butylmethyldiethoxysilane, t-amylmethyldiethoxy silane, diphenyldimethoxysilane, phenylmethyldimethoxysilane, diphenyldiethoxysilane, bis o-tolyldimethoxysilane, bis m-tolyldimethoxysilane, bis p-tolyl dimethoxysilane, bis p-tolyl diethoxysilane, bis ethylphenyl dimethoxysilane, dicyclopentyldimethoxysilane, dicyclohexyldimethoxysilane, cyclohexylmethyldimethoxysilane, cyclohexylmethyldiethoxysilane, ethyltrimethoxysilane, ethyltriethoxysilane, vinyltrimethoxysilane, methyltrimethoxysilane, n-propyltriethoxysilane, decyltrimethoxysilane, decyltriethoxysilane, phenyltrimethoxysilane, γ-chloropropyltrimethoxysilane, methyltriethoxysilane, vinyltriethoxysilane, t-butyltriethoxysilane, thexyltrimethoxysilane, n-butyltriethoxysilane, iso-butyltriethoxysilane, phenyltriethoxysilane, γ-aminopropyltriethoxysilane, chlortriethoxysilane, ethyltriisopropoxysilane, vinyltributoxysilane, cyclohexyltrimethoxysilane, cyclohexyltriethoxysilane, 2-norbornane trimethoxysilane, 2-norbornane triethoxysilane, 2-norbornane methyldimethoxysilane, ethyl silicate, butyl silicate, trimethylphenoxysilane, methyltriallyloxysilane, vinyltris (β-methoxyethoxysilane), vinyltriacetoxy silane, dimethyltetraethoxydisiloxane, methyl(3,3,3-trifluoro-n-propyl)dimethoxysilane, cyclohexylethyldimethoxysilane, cyclopentyl-t-butoxydimethoxysilane, diisobutyldimethoxysilane, isobutylisopropyldimethoxysilane, n-propyltrimethoxysilane, di-n-propyldimethoxysilane, t-butylethyldimethoxysilane, t-butylpropyldimethoxysilane, t-butyl-t-butoxydimethoxysilane, isobutyltrimethoxysilane, cyclohexylisobutyldimethoxysilane, di-sec-butyldimethoxysilane, isobutylmethyldimethoxysilane, bis(decahydroisoquinolin-2-yl)dimethoxysilane, diethylaminotriethoxysilane, dicyclopentyl-bis(ethylamino)silane, tetraethoxysilane, tetramethoxysilane, isobutyltriethoxysilane, t-butyltrimethoxysilane, i-butyltrimethoxysilane, i-butylsec-butyldimethoxysilane, ethyl(perhydroisoquinolin-2-yl)dimethoxysilane, tri(isopropenyloxy)phenylsilane, i-butyl i-propyl dimethoxysilane, cyclohexyl i-butyldimethoxysilane, cyclopentyl i-butyldimethoxysilane, cyclopentylisopropyldimethoxysilane, phenyltriethoxylane, and p-tolylmethyldimethoxysilane.

In some embodiments, the organosilicon compounds are selected from the group consisting of ethyltriethoxysilane, n-propyltriethoxysilane, n-propyltrimethoxysilane, t-butyltriethoxysilane, t-butylmethyldimethoxysilane, t-butylmethyldiethoxysilane, t-butylethyldimethoxy silane, t-butylpropyldimethoxysilane, t-butyl t-butoxydimethoxysilane, t-butyltrimethoxysilane, i-butyltrimethoxysilane, isobutylmethyldimethoxysilane, i-butylsec-butyldimethoxysilane, ethyl (perhydroisoquinoline 2-yl) dimethoxysilane, bis(decahydroisoquinolin-2-yl)dimethoxysilane, tri(isopropenyloxy)phenylsilane, thexyltrimethoxysilane, vinyltriethoxysilane, phenyltriethoxysilane, phenyltrimethoxysilane, vinyltributoxysilane, diphenyldimethoxysilane, diisopropyldimethoxysilane, diisobutyldimethoxysilane, i-butyl i-propyldimethoxysilane, cyclopentyl t-butoxydimethoxysilane, dicyclopentyldimethoxysilane, cyclohexylmethyldimethoxysilane, cyclohexyl i-butyldimethoxysilane, cyclopentyl i-butyldimethoxysilane, cyclopentylisopropyldimethoxysilane, di-sec-butyldimethoxysilane, diethylaminotriethoxysilane, tetraethoxysilane, tetramethoxysilane, isobutyltriethoxysilane, phenylmethyldimethoxysilane, phenyltriethoxylane, bis p-tolyldimethoxysilane, p-tolylmethyldimethoxysilane, dicyclohexyldimethoxysilane, cyclohexylethyldimethoxysilane, 2-norbornanetriethoxysilane, 2-norbornanemethyldimethoxysilane, diphenyldiethoxysilane, methyl(3,3,3-trifluoro-n-propyl)dimethoxysilane, and ethyl silicate. In some embodiments, component (c) compounds are used alone or in combination with other component (c) compounds.

In some embodiments, the organosilicon compounds adjust the amount of xylene-insoluble portion. In some embodiments, the amount of xylene-insoluble portion depends on the type and amount of the organosilicon compound as well as the polymerization temperature. In some embodiments, the polymerization temperature is 75° C., and the lower limit of the molar ratio of the organosilicon compound and the organoaluminum compound (organosilicon compound/organoaluminum) is 0.015, alternatively 0.018. In some embodiments, the upper limit of the ratio is 0.30, alternatively 0.20, alternatively 0.10. In some embodiments, the molar ratio of the organosilicon compound and the organoaluminum compound is in a range selected from the group consisting of 0.015 to 0.30, 0.015 to 0.20, 0.015 to 0.10, 0.018 to 0.30, 0.018 to 0.20, and 0.018 to 0.10.

In some embodiments, a phthalate-based compound is an internal electron donor compound, elevated polymerization temperature leads to the increase of xylene-insoluble portion, and the lower limit and the upper limit of the molar ratio of the organosilicon compound and the organoaluminum compound (organosilicon compound/organoaluminum) are lowered. In some embodiments, the polymerization temperature is 80° C., and the lower limit of the molar ratio, with a phthalate-based compound, is 0.010, alternatively 0.015, alternatively 0.018. The upper limit of the molar ratio is 0.20, alternatively 0.14, alternatively 0.08. In some embodiments, the range of the molar ratio is selected from the group consisting of 0.010 to 0.20, 0.010 to 0.14, 0.010 to 0.08, 0.015 to 0.20, 0.015 to 0.14, 0.015 to 0.08, 0.018 to 0.20, 0.018 to 0.14, and 0.018 to 0.08.

In some embodiments, component (b) is a trialkylaluminum, and component (c) is an organosilicon compound. In some embodiments, the trialkylaluminum is selected from the group consisting of triethylaluminum and triisobutylaluminum. In some embodiments, the organosilicon compound is selected from the group consisting of dicyclopentyldimethoxysilane, cyclohexylmethyldimethoxysilane, and diisopropyldimethoxysilane.

In some embodiments, the propylene polymer (component (a1)) is polymerized in multiple polymerization reactors. In some embodiments, the ethylene/α-olefin copolymer (component (a2)) ise polymerized in a plurality of polymerization reactors.

In some embodiments, the method for obtaining the polymerization mixture uses a polymerization vessel having a gradient of monomer concentration or polymerization conditions. In some embodiments, the polymerization vessel is wherein at least two polymerization regions are joined. In some embodiments, monomers are polymerized by gas phase polymerization.

In some embodiments and in the presence of a catalyst, monomers are supplied and polymerized in a polymerization region consisting of a riser pipe, monomers are supplied and polymerized in a downcomer pipe connected to the riser pipe, and the polymerization is carried out between the riser pipe and the downcomer pipe while circulating, and the polymerization product is collected. In some embodiments, the method completely or partially prevents the gas mixture present in the riser pipe from entering the downcomer pipe. Also, a gas, a liquid, or both mixture, having a different composition from the gas mixture present in the riser pipe, is introduced into the downcomer pipe. In some embodiments, the method is as described in Japanese Patent Publication No. 2002-520426.

### <Sheet Molding>

In some embodiments, a sheet molding is formed by molding the polypropylene-based resin composition. FIG. 1 shows a roll of sheet molding 10.

In some embodiments, the sheet molding is produced by a cast molding method.

In some embodiments, the molding temperature is in the range of 150 to 350° C., alternatively 170 to 250° C.

In some embodiments, the thickness of the sheet molding is in the range of more than 0.1 mm to 2.0 mm, alternatively more than 0.1 mm to 1.0 mm, alternatively more than 0.1 mm to 0.5 mm, alternatively more than 0.1 mm to 0.4 mm.

The thickness of the sheet molding is measured using a measuring method such as a beta-ray film thickness meter.

In some embodiments, the sheet molding is used in a low-temperature environment of −50° ° C. to −10° C., alternatively −45° C. to −20° C., alternatively −40° C. to −30° C.

In some embodiments, the high rate impact (unit: J) of the sheet at −40° C. is more than 2.

In some embodiments, the “sheet peeling” of the sheet molding is “O” or higher.

In some embodiments, the rigidity (stiffness) of the sheet molding of is 500 MPa or more, alternatively 700 MPa or more, alternatively 900 MPa or more.

### EXAMPLES

Examples and comparative examples are shown below and are not intended to limit the scope of the present disclosure.

### <Preparation of Copolymer 1>

A solid catalyst, wherein TiCl4 and diisobutyl phthalate as an internal donor were supported on MgCl2, was prepared by the method described in Example 5, lines 46 to 53 of European Patent No. 728769.

Microprolate MgCl2.2.1C2H5OH was produced as follows. In a 2 L autoclave equipped with a turbine stirrer and a suction pipe, 48 g of anhydrous MgCl2, 77 g of anhydrous C2H5OH, and 830 mL of kerosene were placed in an inert gas at room temperature. The contents were heated to 120° C. with stirring, thereby yielding an adduct of MgCl2 and alcohol. The adduct was melted and mixed with the dispersant. The nitrogen pressure inside the autoclave was maintained at 15 atmospheres. The suction pipe of the autoclave was externally heated to 120° C., using a heating jacket. The suction pipe had an inner diameter of 1 mm and a length of 3 m from an inlet end of the heating jacket to the outlet end. The mixture flowed through this pipe at a speed of 7 m/sec. At the outlet of the pipe, the dispersion was collected with stirring into a 5 L flask containing 2.5 L of kerosene and externally cooled with a jacket, which maintained the initial temperature at −40° C. The final temperature of the dispersion was 0° C. A spherical solid product, constituting the dispersed phase of the emulsion, was allowed to settle out, separated by filtration, washed with heptane, and dried. These operations were performed in an inert gas atmosphere. MgCl2.3C2H5OH in the form of solid spherical particles with a maximum diameter of 50 μm or less was obtained. Yield was 130 g. The product was freed of alcohol by gradually increasing the temperature from 50° C. to 100° C. in a stream of nitrogen until the alcohol content per mole of MgCl2 was reduced to 2.1 mol.

A 500 mL cylindrical glass reactor equipped with a filtration barrier was charged with 225 mL of TiCl4 at 0° C., and 10.1 g (54 mmol) of the microspheroidal MgCl2.2.1C2H5OH was added for 15 minutes while the contents were stirred. Thereafter, the temperature was raised to 40° C., and 9 mmol of diisobutyl phthalate was added. The temperature was raised to 100° C. over 1 hour and stirring was continued for an additional 2 hours. TiCl4 was then removed by filtration, and 200 mL of TiCl4 was added with stirring at 120° C. for an additional hour. Finally, the contents were filtered and washed with n-heptane at 60° C. until the filtrate was free of chloride ions. The catalyst component contained 3.3% by weight of Ti and 8.2% by weight of diisobutyl phthalate.

With the solid catalyst, triethylaluminum (TEAL) as an organoaluminum compound, and dicyclopentyldimethoxysilane (DCPMS) as an external electron donor compound, contacting was carried out at 12° ° C. for 24 minutes in the amount such that the weight ratio of TEAL to the solid catalyst was 20, and the weight ratio of TEAL/DCPMS was 10 (0.05 when converted to the organosilicon compound/organoaluminium molar ratio).

Prepolymerization was carried out by holding catalyst (X) in a suspended state at 20° C. for 5 minutes in liquid propylene.

The resulting prepolymerized product was introduced into the first stage polymerization reactor of a polymerization apparatus, equipped with two stages of polymerization reactors in series. Propylene was supplied to produce a propylene homopolymer. Subsequently, propylene homopolymer, propylene, and ethylene were supplied to the second stage polymerization reactor to produce an ethylene/propylene copolymer. During the polymerization, temperature and pressure were adjusted, and hydrogen was used as a molecular weight regulator.

The polymerization temperature and the ratio of reactants were as follows: in the first reactor, the polymerization temperature and hydrogen concentration were 80° C. and 0.012 mol %, respectively, and in the second reactor, the polymerization temperature, hydrogen concentration, and the ratio of ethylene to the total of ethylene and propylene were 80° C., 1.06 mol %, and 0.49 mol ratio, respectively. Furthermore, the residence time distributions of the first and second stages were adjusted such that the amount of ethylene/propylene copolymer was 35% by weight. The targeted copolymer 1 was obtained.

The resulting copolymer 1 was a polymerized mixture of component (a1), which was a propylene polymer constituting the continuous phase, and component (a2), which was an ethylene/propylene copolymer constituting the rubber phase, and was a polypropylene-based resin (A).

For copolymer 1, molecular weight distribution M_{w}/Mₙ of component (a1), ethylene-derived unit content of component (a1), weight ratio component (a2)/[component (a1)+component (a2)], ethylene-derived unit content of component (a2), the XSIV of component (a1)+component (a2), and the MFR of component (a1)+component (a2) are shown in Table 1.

In Table 1, the catalyst (X) containing a phthalate-based compound, as component (a), is represented as “Pht”, and the catalyst (X) containing a succinate-based compound, as component (a), is represented as “Suc”. The catalyst (X) obtained by above method is indicated as “Pht-1” in Table 1.

### <Preparation of Copolymers 3,5-6>

The ratio of ethylene to the total of ethylene and propylene in the second reactor was changed such that the content of ethylene-derived units in component (a2) was as shown in Table 1. Except for this modification, Copolymers 2-3, and 5 were obtained using the same manufacturing method as in the case of Copolymer 1. It is believed that regarding copolymer 6, the targeted copolymer was obtained because the content of ethylene-derived units in component (a2) was high and production was difficult (the values in Table 1, except for ΔHc, are the target values).

### <Preparation of Copolymer 4>

A solid catalyst, wherein Ti and diisobutyl phthalate as an internal donor were supported on MgCl2, was prepared by the method described in paragraph 0032, lines 21 to 36 of Japanese Patent Application No. JP-A-2004-27218.

Under a nitrogen atmosphere at 120° C., 56.8 g of anhydrous magnesium chloride was dissolved in 100 g of absolute ethanol, 500 mL of vaseline oil “CP15N” manufactured by Idemitsu Kosan Co., Ltd., and 500 mL of silicone oil “KF96” manufactured by Shin-Etsu Silicone Co., Ltd. This solution was stirred for 2 minutes at 120° C. and 5000 rpm using a TK homomixer manufactured by Tokushu Kika Kogyo Co., Ltd. While maintaining stirring, the solution was poured into 2 L of anhydrous heptane, without exceeding 0° C. The resulting white solid was washed with anhydrous heptane, dried under vacuum at room temperature, and partially deethanolized under a nitrogen stream, thereby obtaining 30 g of a spherical solid of MgCl2.1.2C2H5OH.

30 g of spherical solid was suspended in 200 mL of anhydrous heptane. While stirring at 0° C., 500 mL of titanium tetrachloride was added dropwise over 1 hour. Next, under heating, the temperature reached 40° C., 4.96 g of diisobutyl phthalate was added, and then, the temperature was raised to 100° C. in about 1 hour. After a reaction at 100° C. for 2 hours, a solid portion was collected by hot filtration. Thereafter, 500 mL of titanium tetrachloride was added to the reaction mixture and stirred, followed by reaction at 120° C. for 1 hour. After the reaction was completed, the solid portion was collected again by hot filtration and washed seven times with 1.0 L of hexane at 60° C., and three times with 1.0 L of hexane at room temperature, thereby yielding a solid catalyst. The titanium content in the resulting solid catalyst component was 2.36% by weight.

Using the solid catalyst, the residence time distribution in the first and second stages was changed such that the weight ratio of component (a2)/[component (a1)+component (a2)] was as shown in Table 1. Except for this modification, copolymer 4 was obtained by the same manufacturing method as in the case of copolymer 1.

The catalyst (X) obtained here after contact with TEAL and DCPMS is indicated as “Pht-2” in Table 1.

### <Preparation of Copolymers 7-8>

The hydrogen concentration in the second stage reactor was changed such that the XSIV of component (a1)+component (a2) was the value listed in Table 1. The hydrogen concentration in the first stage was adjusted, thereby adjusting the MFR of component (a1)+component (a2) to the value listed in Table 1. Copolymers 7-8 were obtained in the same manner as in the case of Copolymer 1, except for the above.

<Preparation of Copolymer r9>

The hydrogen concentration in the first stage was adjusted, thereby adjusting the MFR of component (a1)+component (a2) to the value shown in Table 1. Except for this modification, copolymer r9 was obtained using the same manufacturing method as in the case of copolymer 1.

### <Preparation of Copolymer 10>

A solid catalyst was prepared as described in Examples of Japanese Patent Application Publication No. 2011-500907, using the following procedure.

Into a 500 mL four-necked round bottom flask purged with nitrogen, 250 mL of TiCl4 was introduced at 0° C. With stirring, 10.0 g of microspheroidal MgCl2.1.8C2H5OH (prepared as described in Example 2 of U.S. Pat. No. 4,399,054, but operated at 3000 rpm instead of 10000 rpm), and 9.1 mmol of diethyl-2,3-(diisopropyl)succinate were added. The temperature was raised to 100° C. and held for 120 minutes. Then, stirring was stopped, the solid product was allowed to settle, and the supernatant liquid was filtered. The following operation was repeated twice: 250 mL of fresh TiCl4 was added, the mixture was allowed to react at 120° C. for 60 minutes, and the supernatant liquid was filtered. The solid was washed six times with anhydrous hexane (6×100 mL) at 60° C.

The solid catalyst, TEAL, and DCPMS were mixed at room temperature for 5 minutes, in such of an amount that the weight ratio of TEAL to the solid catalyst was 18 and the weight ratio of TEAL/DCPMS was 10. Prepolymerization was carried out by holding the resulting catalyst (X) in a suspended state at 20° C. for 5 minutes, in liquid propylene.

The resulting prepolymerized product was introduced into the first stage polymerization reactor of a polymerization apparatus equipped with two stages of polymerization reactors in series. Propylene was supplied to produce a propylene homopolymer. Subsequently, propylene homopolymer, propylene, and ethylene were supplied to the second stage polymerization reactor to produce an ethylene/propylene copolymer. During the polymerization, temperature and pressure were adjusted, and hydrogen was used as a molecular weight regulator.

The polymerization temperature and the ratio of reactants were as follows: In the first reactor, the polymerization temperature and hydrogen concentration were 80° C. and 0.030 mol %, respectively, and in the second reactor, the polymerization temperature, hydrogen concentration, and the ratio of ethylene to the total of ethylene and propylene were 80° C., 1.06 mol %, and 0.44 mol ratio, respectively. Furthermore, the residence time distributions of the first and second stages were adjusted such that the weight ratio component (a2)/[component (a1)+component (a2)] was 35% by weight. The copolymer 10 shown in Table 1 was obtained.

Copolymers 2 to 10 were analyzed in the same manner as for Copolymer 1. The results are shown in Table 1.

TABLE 1

| | Copol- | Copol- | Copol- | Copol- | Copol- | Copol- | Copol- | Copol- | Copol- | Copol- |
|---|---|---|---|---|---|---|---|---|---|---|
| | ymer | ymer | ymer | ymer | ymer | ymer | ymer | ymer | ymer | ymer |
| Type | 1 | 2 | 3 | 4 | 5 | 6 | 7 | 8 | 9 | 10 |
| Catalyst | Pht-1 | Pht-1 | Pht-1 | Pht-2 | Pht-1 | Pht-1 | Pht-1 | Pht-1 | Pht-1 | Suc |
| Molecular weight distribution of | 6 | 6 | 6 | 6 | 6 | 6 | 6 | 6 | 6 | 9 |
| component (a1) Mw/Mn | | | | | | | | | | |
| Content of ethylene-derived unit of | 0 | 0 | 0 | 0 | 0 | 0 | 0 | 0 | 0 | 0 |
| component (a1) (weight %) | | | | | | | | | | |
| Type of component (a2) | C2C3 | C2C3 | C2C3 | C2C3 | C2C3 | C2C3 | C2C3 | C2C3 | C2C3 | C2C3 |
| Weight ratio component | 35 | 35 | 35 | 25 | 35 | 35 | 35 | 35 | 35 | 35 |
| (a2)/[component (a1) + | | | | | | | | | | |
| component (a2)] (weight %) | | | | | | | | | | |
| Content of ethylene-derived unit of | 50 | 29 | 80 | 50 | 23 | 88 | 50 | 50 | 50 | 50 |
| component (a2) (weight %) | | | | | | | | | | |
| Calorific amount ΔHc of the | 1.9 | 0.0 | 7.2 | 1.4 | 0.0 | — | 1.9 | 1.9 | 1.9 | 1.7 |
| crystallization peak | | | | | | | | | | |
| between 85-105° C. of | | | | | | | | | | |
| DSC of component (A) (J/g) | | | | | | | | | | |
| XSIV of component (a1) + | 3.2 | 3.2 | 3.2 | 3.2 | 3.2 | 3.2 | 2.3 | 5.9 | 3.2 | 3.2 |
| component (a2) (dl/g) | | | | | | | | | | |
| MFR of component (a1) + | 0.4 | 0.4 | 0.4 | 0.4 | 0.4 | 0.4 | 0.4 | 0.4 | 4.5 | 0.4 |
| component (a2) [230° C. | | | | | | | | | | |
| 2.16 kg) (g/10 min) | | | | | | | | | | |

Each measurement value in Table 1 was measured by the following method.

<M_{w}/Mₙ of Component (a1)>

A 2.5 g sample of component (a1) polymerized in the first stage reactor was used as the measurement sample. The number average molecular weight (Mₙ) and weight average molecular weight (M_{w}) were measured. The weight average molecular weight (M_{w}) was divided by the number average molecular weight (Mₙ), thereby determining the molecular weight distribution (M_{w}/Mₙ). The device used was PL GPC220 manufactured by Polymer Laboratories. The mobile phase was 1,2,4-trichlorobenzene containing an antioxidant. The columns were UT-G (1 column), UT-807 (1 column), and UT-806M (2 columns), manufactured by Showa Denko., connected in series. A differential refractometer was used as a detector. The same solvent, as the mobile phase, was used as the solvent for the sample solution. A measurement sample was prepared by dissolving for 2 hours under stirring at the temperature of 150° C. in a sample concentration of 1 mg/mL. 500 μL of the resulting sample solution was injected into the column. Measurement was performed at a flow rate of 1.0 mL/minute, a temperature of 145° C., and a data collection interval of 1 second. The column was calibrated using cubic approximation with a polystyrene standard sample (Shodex STANDARD, manufactured by Showa Denko K.K.,) with a molecular weight of 5.8 million to 7.45 million. The Mark-Houwink-Sakurada coefficients of K=1.21×10-4, α=0.707 for polystyrene standard samples, and K=1.37×10-4 and α=0.75 for polypropylene homopolymers, propylene random copolymers, and polypropylene-based polymers were used.

<Total Ethylene Amount of Copolymer, Content of Ethylene-Derived Units in Component (a1)>

For copolymer samples dissolved in a mixed solvent of 1,2,4-trichlorobenzene/deuterated benzene, AVANCE III HD400, manufactured by Bruker, (13C resonance frequency 100 MHz) was used to obtain a 13C-NMR spectrum under the following conditions: measurement temperature 120° C., flip angle 45 degrees, pulse interval 7 seconds, sample rotation speed 20 Hz, and number of integrations 5000 times.

Using the resulting spectrum, the total ethylene content of the copolymer (weight %) was determined by the method described in Kakugo, Y. Naito, K. Mizunuma and T. Miyatake, Macromolecules, 15, 1150-1152 (1982).

When measuring component (a1) as a sample, the total ethylene amount (weight %) obtained was the ethylene unit content (weight %) of component (a1).

<Ethylene Unit Content in Component (a2)>

The ethylene unit content (weight %) of component (a2) was determined by calculating in the same manner as the total ethylene amount, except that instead of the integrated intensity of Tββ obtained when measuring the total ethylene amount of the copolymer, the integrated intensity T′ββ obtained by the following formula was used.

$${T}^{′} ββ = 0.98 \times S αγ \times A / ( 1 - 0.98 \times A )$$

wherein A=Saγ/(Saγ+Saδ), which is calculated from Saγ and Saδ.
<Weight Ratio Component (a2)/[Component (a1)+Component (a2)]>

$$Component ( a 2 ) \text{} / [ component ( a 1 ) + component ( a 2 ) ( unit : weight \% ) = total ethylene amount of copolymer / ( ethylene unit content in component ( a 2 ) / 100 )$$

<XSIV of Component (a1)+Component (a2)>

A xylene-soluble portion of the copolymer was obtained by the following method. The intrinsic viscosity (XSIV) of the xylene-soluble portion was measured.

2.5 g of the copolymer sample was placed in a flask containing 250 mL of o-xylene (solvent), stirred for 30 minutes using a hot plate and reflux device at 135° ° C. while purging with nitrogen to dissolve, and then cooled at 25° C. for 1 hour. The resulting solution was filtered using filter paper. 100 mL of the filtrate after filtration was collected, transferred to an aluminum cup, evaporated to dryness at 140° C. while purging with nitrogen, and left standing at room temperature for 30 minutes, thereby obtaining a xylene-soluble portion.

The intrinsic viscosity was measured in tetrahydronaphthalene at 135° C. using an automatic capillary viscosity measuring device (SS-780-H1, manufactured by Shibayama Scientific Instruments Co., Ltd.).

<MFR of Component (a1)+Component (a2)>

0.05 g of H-BHT manufactured by Honshu Chemical Industry Co., Ltd., was added to 5 g of a sample of the copolymer. After homogenization by dry blending, according to JIS K7210-1., MFR was measured in accordance with JIS K6921-2 at a temperature of 230° C. and a load of 2.16 kg.

### <DSC of Polypropylene-Based Resin (A)>

### [Calorific Value of Crystallization Peak (ΔHc) Between 85 and 105° C.]

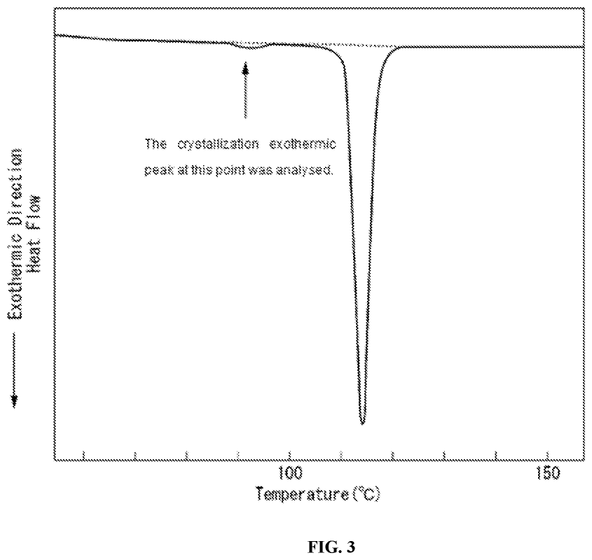

Approximately 5 mg of each copolymer in Table 1 was weighed with an electronic balance. Differential scanning calorimetry (DSC) was performed on each sample, using Q-200 manufactured by TA Instruments in accordance with ISO 11357-1 and ISO 11357-3, thereby normalizing the influence of thermal history. The sample was heated to 230° C. and held for 5 minutes, then cooled to 30° C. at a cooling rate of 5° C./minute, and differential scanning calorimetry was performed during cooling. Among the exothermic peaks that indicate crystallization in this measurement result, the exothermic peak existing between 85 and 105° C. was compared to the baseline (virtual baseline described in ISO 11357-1:2016 (en) 3.7.3) and the exothermic peak. The calorific value ΔHc (J/g) of the crystallization peak was determined based on the area surrounded by the area. An example of a DSC chart is shown in FIG. 3.

### EXAMPLES AND COMPARATIVE EXAMPLES

Components was formulated according to the composition shown in Table 2. 0.2 parts by weight of B225 manufactured by BASF, as an antioxidant, and 0.05 parts by weight of calcium stearate manufactured by Tannan Kagaku Kogyo Co., Ltd., as a neutralizing agent, were added to total 100 parts by weight of the amount of component (A). The mixture was stirred and mixed for 1 minute using a Henschel mixer. The mixture was melt-kneaded and extruded at a cylinder temperature of 230° C., using a co-directional twin-screw extruder TEX-30a manufactured by JSW Corporation. After cooling the strand in water, the composition was cut with a pelletizer, thereby obtaining pellets of the polypropylene-based resin composition.

The pellets were subjected to a sheet molding machine, thereby obtaining a sheet molded body. However, regarding Example 1-2 and Comparative Example 1-2, talc as component (C) was blended, to the total of 100 parts by weight of component (A) contained in the above pellets, in the amount listed in Table 2. The mixture was melt-kneaded, thereby forming a polypropylene-based resin composition, which was subjected to a sheet molding machine, thereby obtaining a sheet molded body. Physical properties of the sheet molded bodies are show in Table 2.

TABLE 2

| | | Example | Example | Example | Example | Comparative | Comparative |
|---|---|---|---|---|---|---|---|
| Type | | 1-1 | 1-2 | 2 | 3 | example 1-1 | example 1-2 |
| Component (A) | Type | Copolymer 1 | Copolymer 1 | Copolymer 2 | Copolymer 3 | Copolymer 4 | Copolymer 4 |
| | Weight ratio | 100 | 100 | 100 | 100 | 100 | 100 |
| | (parts by weight) | | | | | | |
| Component (C) | Type | None | Talc | None | None | None | Talc |
| | Content weight ratio | 0 | 20 | 0 | 0 | 0 | 20 |
| | (parts by weight) to 100 parts | | | | | | |
| | by weight of component (A) | | | | | | |
| Other component | Antioxidant neutralizing agent | Contained | Contained | Contained | Contained | Contained | Contained |

| | | | | | | |
|---|---|---|---|---|---|---|
| MFR of the composition without component (C) [230° C. | 0.4 | 0.4 | 0.4 | 0.4 | 0.4 | 0.4 |
| 2.16 kg] (g/10 min) | | | | | | |
| PP factory productivity (⊚: Excellent ◯: Good Δ: Fair | ⊚ | ⊚ | ◯ | ◯ | ⊚ | ⊚ |
| X: Not possible) | | | | | | |
| Rigidity stiffness (MPa) | 880 | 1260 | 780 | 900 | 1240 | 1800 |
| High rate impact (J) @−40° C. | 4 | 4 | 3 | >20 | <1 | <1 |
| Sheet peeling (⊚: Excellent ◯: Good Δ: Fair | ⊚ | ⊚ | ⊚ | ◯ | ⊚ | Δ |
| X: Not acceptable) | | | | | | |
| Sheet moldability (◯: Good Δ: Acceptable | ◯ | ◯ | ◯ | ◯ | ◯ | Δ |
| X: Not acceptable) | | | | | | |
| Sheet productivity (◯: Good Δ: Acceptable | ◯ | ◯ | ◯ | ◯ | ◯ | Δ |
| X: Not possible) | | | | | | |

| | | Comparative | Comparative | Comparative | Comparative | Comparative | Comparative |
|---|---|---|---|---|---|---|---|
| Type | | example 2 | example 3 | example 4 | example 5 | example 6 | example 7 |
| Component (A) | Type | Copolymer 5 | Copolymer 6 | Copolymer 7 | Copolymer 8 | Copolymer 9 | Copolymer 10 |
| | Weight ratio | 100 | 100 | 100 | 100 | 100 | 100 |
| | (parts by weight) | | | | | | |
| Component (C) | Type | None | None | None | None | None | None |
| | Content weight ratio | 0 | 0 | 0 | 0 | 0 | 0 |
| | (parts by weight) to 100 parts | | | | | | |
| | by weight of component (A) | | | | | | |
| Other component | Antioxidant neutralizing agent | Contained | Contained | Contained | Contained | Contained | Contained |

| | | | | | | |
|---|---|---|---|---|---|---|
| MFR of the composition without component (C) [230° C. | 0.4 | — | 0.4 | 0.4 | 4.5 | 0.4 |
| 2.16 kg] (g/10 min) | | | | | | |
| PP factory productivity (⊚: Excellent ◯: Good Δ: Fair | Δ | X | ⊚ | Δ | ⊚ | Δ |
| X: Not possible) | | | | | | |
| Rigidity stiffness (MPa) | 780 | — | 900 | 930 | — | 940 |
| High rate impact (J) @−40° C. | <1 | — | 1.5 | <1 | — | <1 |
| Sheet peeling (⊚: Excellent ◯: Good Δ: Fair | ⊚ | — | ⊚ | ⊚ | ⊚ | ⊚ |
| X: Not acceptable) | | | | | | |
| Sheet moldability (◯: Good Δ: Acceptable | ◯ | — | ◯ | Δ | X | ◯ |
| X: Not acceptable) | | | | | | |
| Sheet productivity (◯: Good Δ: Acceptable | ◯ | — | ◯ | ◯ | X | ◯ |
| X: Not possible) | | | | | | |

Each component in Table 2 is as follows.

Component (A) is copolymers 1 to 10 in Table 1.

### Component (C) is an Inorganic Filler:

Talc: Neotalc UNI05, which was commercially available from Neolite Kosan Co., Ltd., having a volume average particle diameter measured by laser diffraction method: 5 μm

Other ingredients are the following additives.
Antioxidant: B225, which was commercially available from BASF
Neutralizing agent: Calcium stearate, which was commercially available from Tannan Chemical Industry Co., Ltd.

The measurement results and evaluation results in Table 2 are values measured and evaluated by the following method.

### <PP Factory Productivity>

The ease of producing component (A) using the above method was evaluated on the following four scales.
“⊚”: Excellent=Manufactured without any problems.
“◯”: Good=Manufactured without problems.
“Δ”: Fair=Barely able to produce, but production volume and/or fluff (powder) properties were slightly inferior.
“x”: Not possible=A problem occurred during production and production could not be completed.

### <Fluidity MFR>

The MFR of the polypropylene-based resin composition, when component (C) was not included, was measured in accordance with JIS K7210-1 and based on JIS K6921-2 under the conditions at a temperature of 230° C. and a load of 2.16 kg.

### <Sheet Molding>

Using a 3-type, 3-layer, φ25 mm film/sheet molding device manufactured by Thermoplastics Industries Co., Ltd., the cylinder-to-die temperature was controlled at 250° C. The molten resin, extruded from the die using the pellets as raw material, was taken off while cooling and solidifying with a cooling roll at a molding speed of 1.0 m/min, thereby obtaining a sheet with a thickness of 400 μm.

The formed sheet was conditioned in a constant temperature room at 23° ° C. for 48 hours or more, and then used as a sample.

### <Rigidity Stiffness>

Based on JIS P8125, a sheet-shaped piece with a measurement span length of 5 cm was bent at warp angle of 15° to measure the load using V-5 stiffness tester (Model 150-B) manufactured by Taber Instrument Corporation. Stiffness was determined from the observed load.

### <High-Rate Impact>

Based on JIS K7211-2, a sample was hit at a constant velocity in the center of the surface by a striker hydraulically controlled in an atmosphere of −40° C., using a puncture impact tester (Hydroshot HITS-P10) manufactured by Shimadzu Corporation. The puncture impact test energy was measured from the obtained impact force-displacement diagram.

### <Sheet Peeling>

A section with thickness of 20 μm was sliced from the center of the sheet in the direction perpendicular to the surface using a rotary microtome (model: RU-S) manufactured by Japan Microtome Research Institute Co., Ltd. A polarizing microscope (BX-50) manufactured by Olympus Corporation was used for observation. The peeling state of the interface between propylene polymer (a1), copolymer of α-olefin (a2), ethylene/α-olefin polymer (B), and inorganic filler (C) was evaluated in the following four stages.
“⊚”: Excellent: No peeling at all.
“◯”: Good: Slight peeling is observed.
“Δ”: Fair: Peeling is partially observed.
“x”: Not acceptable: Peeling is seen throughout.

### <Sheet Moldability>

The sheet was evaluated on the following three scales.
“◯”: Good: A good product with no problems in shape, thickness was obtained.
“Δ”: Acceptable: Some defective products were found.
“x”: Not acceptable: Good product was not obtained.

### <Sheet Productivity>

In carrying out the sheet molding, the degree of sheet productivity due to the problem such as occurrence of breakage during molding was evaluated on the following three levels.)
“◯”: Good: There were no problems and production was easy.
“Δ”: Acceptable: A problem occurred and production was somewhat difficult.
“x”: Not possible: A problem occurred, and production of the sheet was difficult.

Comparative Example 1-1 had a low content of component (a2) and had poor impact resistance at temperatures of about −40° C.

Comparative Example 1-2 was obtained by adding component (C) to Comparative Example 1-1, but the impact resistance at temperatures of about −40° C. was not improved, and sheet peeling, sheet moldability, and sheet productivity actually worsened.

In Comparative Example 2, the content of ethylene-derived units in component (a2) was low, and the impact resistance at temperatures of about −40° C. was poor, and although component (A) was produced with difficulty, the production volume and fluff properties were poor.

In Comparative Example 3, the content of ethylene-derived units in component (a2) was high, and component (A) was unable to be produced.

It is believed that Comparative Example 4 had poor impact resistance at temperatures of about −40° C. due to the low XSIV of component (A).

It is believed that because in Comparative Example 5, the XSIV of component (A) was too high, the impact resistance at temperatures of about −40° C. was poor. Although component (A) was manufactured with difficulty, the production amount was low. In addition, sheet moldability was poor. Comparative Example 6 had extremely poor sheet moldability (drawdown resistance) and sheet productivity due to the high fluidity of component (A). As such, the sheet sample was not obtained for evaluating the stiffness or impact resistance at temperatures of about −40° C.

In Comparative Example 7, component (a1) had a large M_{w}/Mₙ and poor impact resistance at temperatures of about −40° C. In addition, although component (A) was produced with difficulty, the yield and fluff properties were poor.

1. A polypropylene-based resin composition comprising:
(A) a polypropylene-based resin (A) including
(a1) a continuous phase consisting of a propylene polymer, having a content of ethylene-derived units of 0.5% by weight or less, based upon the total weight of the propylene polymer, and a ratio (M_{w}/Mₙ) between the weight average molecular weight M_{w} and the number average molecular weight Mₙ of less than 7, and
(a2) from 27 to 45% by weight of a rubber phase consisting of a copolymer of ethylene and an α-olefin having 3 to 10 carbon atoms, based upon the total weight of the polypropylene-based resin (A), wherein the copolymer has a content of ethylene-derived units of 25 to 85% by weight, based upon the total weight of the copolymer, and
(C) an inorganic filler, as an optional component,
wherein
(i) when weight m1 represented as the difference of [total weight of the polypropylene-based resin composition−the weight of the inorganic filler (C)] is 100% by weight,
the weight m2 of the polypropylene-based resin (A) is from 90% by weight or more to below 100% by weight, and
the content of the inorganic filler (C) is 0 to 60 parts by weight with respect to 100 parts by weight of the (A),
wherein
(ii) when the inorganic filler (C) is not included, the MFR of the polypropylene-based resin composition at a temperature of 230° C. and a load of 2.16 kg is 0.1 to 3.0 g/10 min,
wherein
the xylene-soluble portion of the polypropylene-based resin (A) has an intrinsic viscosity in tetrahydronaphthalene at 135° C. of 2.5 to 5.5 dl/g, and
the MFR of the polypropylene-based resin (A) at a temperature of 230° C. and a load of 2.16 kg is 0.1 to 3.0 g/10 minutes.

2. The polypropylene-based resin composition according to claim 1, wherein the polypropylene-based resin (A) having a crystallization peak observed between 85 and 105° C. with a calorific value of 0.5 to 10 J/g in DSC measurement.

3. The polypropylene-based resin composition according to claim 1, wherein propylene polymer (a1) and copolymer (a2) are mixed by polymerization, and polypropylene-based resin (A) is a polymerization mixture prepared by using a catalyst containing:
(a) a solid catalyst containing magnesium, titanium, halogen, and a phthalate-based compound as an electron donor compound,
(b) an organoaluminum compound, and
(c) an organosilicon compound as an external electron donor compound.

4. The polypropylene-based resin composition according to claim 2, wherein propylene polymer (a1) and copolymer (a2) are mixed by polymerization, and polypropylene-based resin (A) is a polymerization mixture prepared by using a catalyst containing:
(a) a solid catalyst containing magnesium, titanium, halogen, and a phthalate-based compound as an electron donor compound,
(b) an organoaluminum compound, and
(c) an organosilicon compound as an external electron donor compound.

5. A method for producing a polypropylene-based resin composition, comprising the step of:
polymerizing ethylene monomer and an α-olefin monomer having 3 to 10 carbon atoms, in the presence of a propylene polymer (a1), thereby yielding a polypropylene-based resin (A), using a catalyst containing:
(a) a solid catalyst containing magnesium, titanium, halogen, and a phthalate-based compound as an electron donor compound,
(b) an organoaluminum compound, and
(c) an organosilicon compound as an external electron donor compound,
wherein the polypropylene-based resin composition is according to claim 1.

6. A sheet molding comprising the polypropylene-based resin composition according to claim 1.

7. The sheet molding according to claim 6, as a container.

8. (canceled)
